(19) United States
(12) Patent Application Publication
(10) Pub. No.: US 2022/0187667 A1
(43) Pub. Date: Jun. 16, 2022

(54) INTEGRATED DRIVER AND TINT SELECTOR

(71) Applicant: Kinestral Technologies, Inc., Hayward, CA (US)

(72) Inventor: Paul Nagel, Hayward, CA (US)

(21) Appl. No.: 17/553,452

(22) Filed: Dec. 16, 2021

Related U.S. Application Data
(60) Provisional application No. 63/126,241, filed on Dec. 16, 2020.
(60) Provisional application No. 63/146,428, filed on Feb. 5, 2021.

(51) Int. Cl. G02F 1/153; G02F 1/163; G02F 1/133; G02F 1/1333; E06B 9/24

(52) U.S. Cl. CPC G02F 1/153; G02F 1/163; G02F 1/13312; G06F 3/03547; E06B 9/24; G02F 2203/01; E06B 2009/2464; G02F 1/13338

(57) ABSTRACT

A modular system for smart windows has tint drivers and interchangeable interfaces, for driving electrochromic devices. Each tint driver has one or more processors and electronic circuitry to drive two electrochromic devices according to a selected tint. Each interchangeable interface is attachable to and removable from each of the tint drivers. A power supply supplies power to the tint drivers. The power supply supplies power via a tint driver to an interchangeable interface attached to the tint driver.

### BACKGROUND

Electrochromic (EC) devices are in present use in electrically tintable windows in both commercial and residential buildings. Typical installations of an EC window system in a building involve both components and wiring, for power and control of window tinting. There is an ongoing need in the art for technological solutions that improve system installation efficiency and reduce total installed system cost, and also for technological solutions that improve the user experience in terms of ease of use, user intuition, user interface, and satisfaction of use. It is in this environment that present embodiments arise.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 depicts an embodiment of a modular smart windows system.

FIG. 2 depicts component placement and wiring of an installed smart windows system in an embodiment of the modular smart windows system.

FIG. 3 illustrates component physical form and wiring connections in embodiments of drivers and interchangeable interfaces of the modular smart windows system.

FIG. 4 illustrates component physical form in embodiments of drivers and interchangeable interfaces of the modular smart windows system.

FIG. 5 illustrates an embodiment of an interchangeable interface as a component of the modular smart windows system.

FIG. 6 illustrates a housing for installation in a building interior and for receiving a driver in an embodiment of the modular smart windows system.

FIG. 7A depicts disassembled physical forms of embodiments of interchangeable interfaces of the modular smart windows system.

FIG. 7B depicts assembled physical forms of the interchangeable interfaces of FIG. 7A.

FIG. 8 illustrates a back box for mounting various modular components in embodiments of the modular smart windows system.

FIG. 9 illustrates a flow diagram of a method of operation of a modular smart windows system, which can be practiced by and with embodiments described herein and variations thereof.

### DETAILED DESCRIPTION

A modular smart windows system described herein solves various technological problems in areas of system installation efficiency improvement, total installed system cost reduction, and improvement of ease of use and user satisfaction. Various embodiments have various components that can be in various combinations for a specific system installation, so that installation time and cost can be tailored to a specific installed smart windows system embodiment. Through customization of a specific system installation, ease of use and user satisfaction may be improved. Examples of both functional and physical aspects of various components are described herein, and variations thereof are readily devised in keeping with these teachings. System considerations are described below, in the form of technological goals achieved by various embodiments, followed by examples of system components and installations.

Generally, tint drivers and driver cables are the largest electronics cost contributors, as to both component cost and installation time and cost. A more distributed installation topology can reduce costs and complexity. Also, it costs less to install commodity power cables over long runs in comparison to custom driver cables, the cost of which accumulates for installation and for large systems can be considerable. A single power cable run can supply power for multiple drivers, reducing installation cost. And, a more distributed installation topology can reduce space requirements for cabinets.

Combining products used in repetitive scenarios can reduce costs. As a specific solution, combining two tint drivers and a tint selector costs less than individual products (e.g., multiple separate components and associated component installation and wiring installation to connect them). There is thus a lower installation cost for a combination product vs. 2+ individual products.

A tint selector next to windows provides a more intuitive experience for the user. Office workers are accustomed to pulling the shades, not getting out an app (e.g., on a computer or smart phone). A tint selector at the window will simplify users needing manual control (vs. using an app). A powered tint selector that wakes up as a user approaches will improve the user experience and perception of the product and system. The above considerations are expressed in various features, components and system embodiments described below, which have technological solutions to various technological problems.

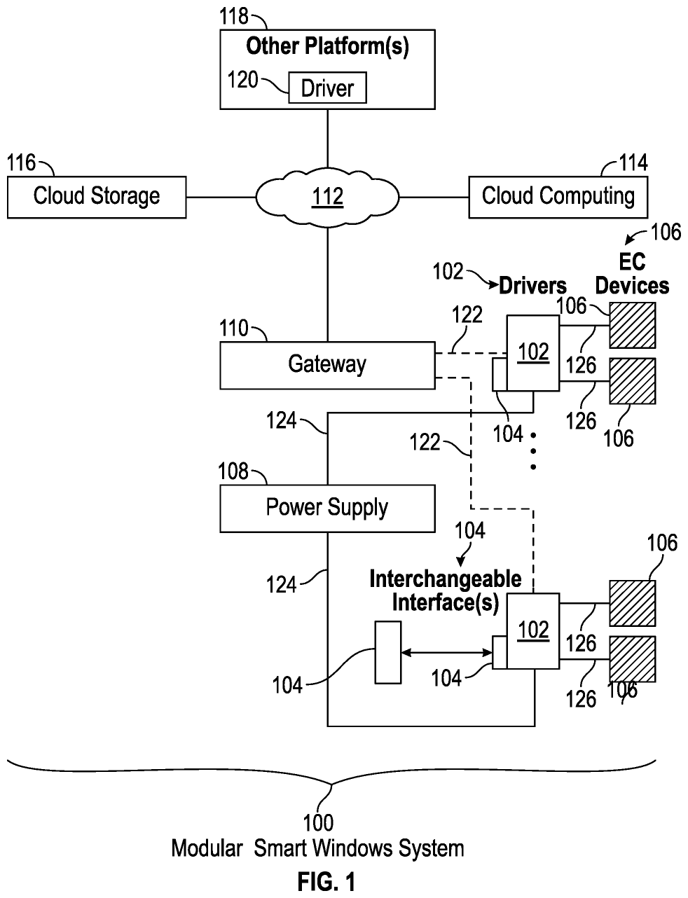

FIG. 1 depicts an embodiment of a modular smart windows system 100. Electrochromic (EC) devices 106 are, for example, in electrically tintable windows that may be installed in a residential or commercial building. The windows themselves and/or the entire system can be termed smart windows, in recognition of the distributed technology therein. In one embodiment, each of multiple drivers 102 (which may also be termed tint drivers) is connected to, drives and controls tinting of two electrochromic devices 106, e.g., embodied in smart windows, through wiring 126. Interchangeable interfaces 104 snap onto or off of each driver 102, for custom configuration. The interchangeable interfaces 104 have various functions, appearances and mechanisms, examples of which are further discussed below. Power supply 108 connects to and supplies power to each of the drivers 102, through wiring 124. In one embodiment, the sets of wiring 124, 126 are made of ordinary, commodity-type wires, suitable for wire pulls during installation in a building, and suitable for carrying appropriate voltage and current.

A gateway 110 communicates wirelessly, e.g., through dashed-line paths 122, with the drivers 102 and also communicates through connection to the cloud 112 (e.g., a network, and more specifically the global communication network known as the Internet). Other connections through the cloud 112 are to cloud computing resources 114 and cloud storage resources 116, for cloud-based contribution to operation of the smart windows system 100. In embodiments that support or integrate with other platforms, there are other connections through the cloud 112 to one or more other platforms 118, each with specialized driver 120. The driver 120 is specific to the platform 118, and exposes the capabilities of the site. It should be appreciated that the gateway 110 is not necessarily required in all system embodiments, and some system versions may operate with local distributed intelligence but without cloud computing and/or cloud storage.

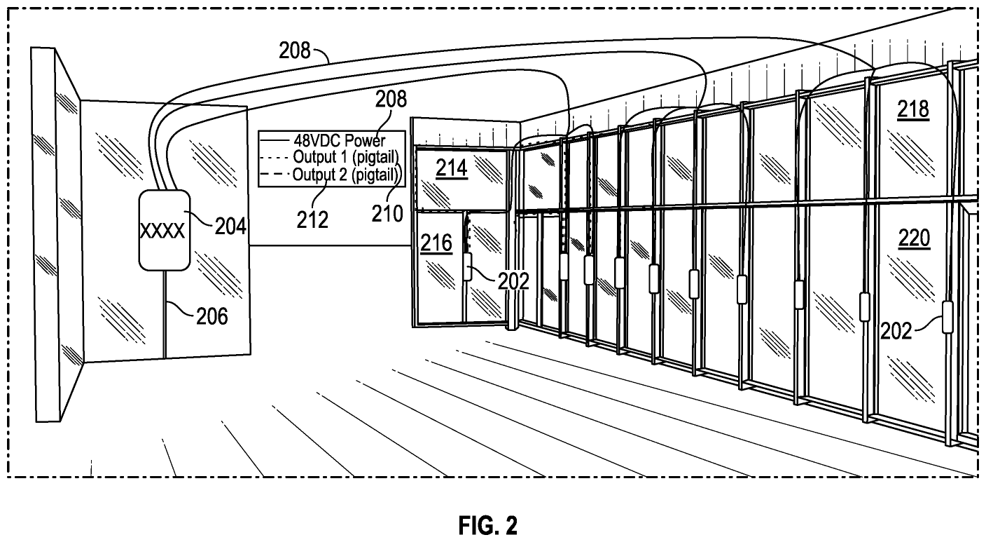

FIG. 2 depicts component placement and wiring of an installed smart windows system in an embodiment of the modular smart windows system. In this embodiment, the system uses in-frame tint driver pigtail cabling. As in FIG. 1, each driver 202 is connected to, drives and controls tinting of two electrochromic devices, here shown as electrochromic windows that may be termed, with the system, smart windows. For example, one of the drivers 202 (at the far set of windows in the drawing) drives smart windows 214, 216, and another of the drivers 202 (at the near set of windows in the drawing) drives smart windows 218, 220. Each driver 202 is connected to 48 Volt DC power 208, e.g., by wiring 124 (see FIG. 1). Each driver 202 has output 1 (pigtail) 210 and output 2 (pigtail) 212, which each connect to a respective smart window. Support equipment 204 is within an enclosure attached to a wall, or alternatively attached to a ceiling or in a closet, and has an AC power connection 206 to a power supply 108 (see FIG. 1, here the component is inside the enclosure). Support equipment 204 also has the connection to 48 Volt DC power 208, to supply power to the drivers 202. In some embodiments, the support equipment 204 also includes the gateway 110 in the same enclosure. Alternatively, the gateway 110 could be mounted elsewhere. Depending on customization with interchangeable interfaces 104, the smart windows system could operate entirely through cloud computing resources 114 and cloud storage resources 116, without need for any of the drivers 202 to have one of the interchangeable interfaces 104 attached thereto. In other embodiments, for individual or paired window tinting through user interaction at one of the drivers 202, a driver 202 could have one of the interchangeable interfaces 104. These configurations of drivers with or without interchangeable interfaces 104 attached, and which interchangeable interface 104 is attached to which driver 202, can be arranged and rearranged readily. Upgrades to new interchangeable interfaces 104 are also readily accomplished during the system lifetime. The modular system is thus customizable both during installation and afterwards, during use.

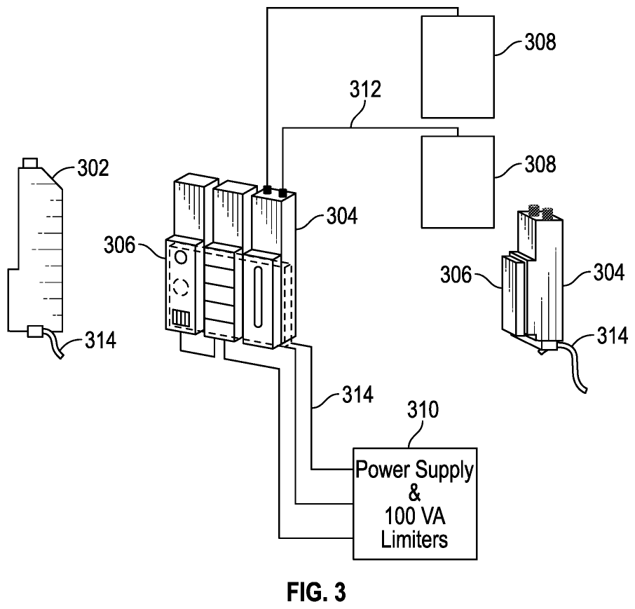

FIG. 3 illustrates component physical form and wiring connections in embodiments of drivers and interchangeable interfaces of the modular smart windows system. Dimensions of an L-shaped driver 302 embodiment with wiring pigtail 314 at the heel of the L, and a narrowed upper stem of the L, are shown to the left in the drawing. The toe or lower front face of the L is shown without an interchangeable interface 104. Another driver 304 embodiment, to the middle and right in the drawing, has a more rectangular, un-tapered upper stem of the L and is shown with an interchangeable interface 306. The wiring pigtail 314 connects to the power supply 310, which is labeled “power supply & 100 VA limiters” to show maximum power capability and power limitation of the power supply 310. At the top of the driver 304 are power cable bulkhead connectors, shown in the middle of the drawing with wiring 312 to two electrochromic devices 308, e.g., smart windows.

The various embodiments of driver 302, 304 in FIG. 3 are dimensioned to fit in a standard 2″×4″ stud depth and accommodate a three-quarter inch wall thickness. The driver cable enters from the top of the assembly. The power connectors are on the bottom of the assembly. In the embodiment on the right in the drawing, an installer pushes to insert or release the connector for power in. In one version, the driver is larger than the exposed opening. For tidy appearance, one version has a custom trim ring and a back box. Another version has a decorative trim ring. Trim rings could be exchangeable, standard ordered or custom ordered with various available finishes and colors, or paintable.

Three different faces are shown on interchangeable interfaces 306 in the middle of the drawing, as examples of different versions or types of interchangeable interface 306. Each interchangeable interface 306 receives power from the power supply 310 through the driver 304 to which the interchangeable interface 306 is attached, for example through a connector. One interchangeable interface 306, on the left, has an air quality sensor (or more than one), a proximity detector, a light level detector, and a light cover. For example, the proximity detector could be implemented with an infrared detector, ultrasonic detector, motion detector, capacitance sensor, or in more sophisticated versions with a camera and image recognition or image classification, etc.

One interchangeable interface 306, in the middle of the three, has buttons and indicia for “tint”, “clear”, “top”, “bottom” and “auto”, e.g., as a keypad. As an example operating scenario, a user could press “top” to select the upper of two smart windows (or “bottom” to select the lower smart window), then press “tint” to tint that selected window (or “clear” to clear that selected window). Or, press “auto” for an automatic tint function, e.g., based on operation through cloud computing resources 114 and cloud storage resources 116, based on local light sensing, time of day, etc., or based on distributed control combining local and cloud-based computing.

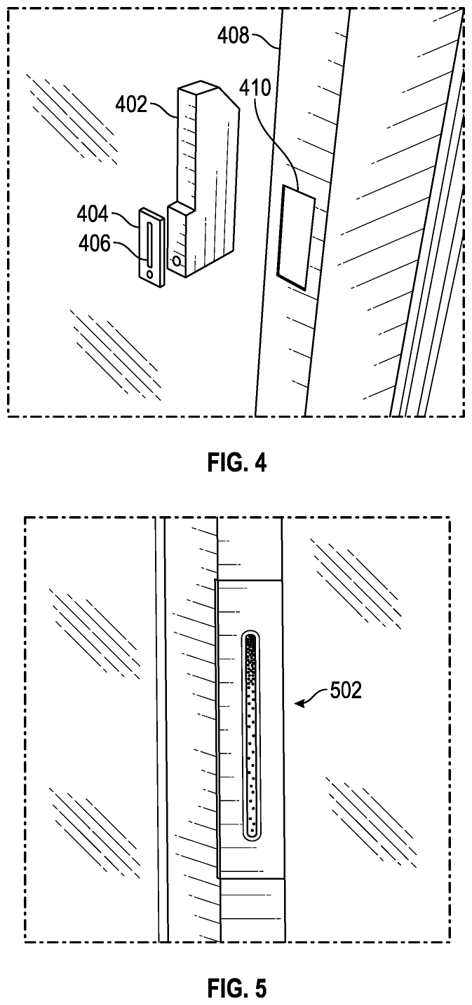

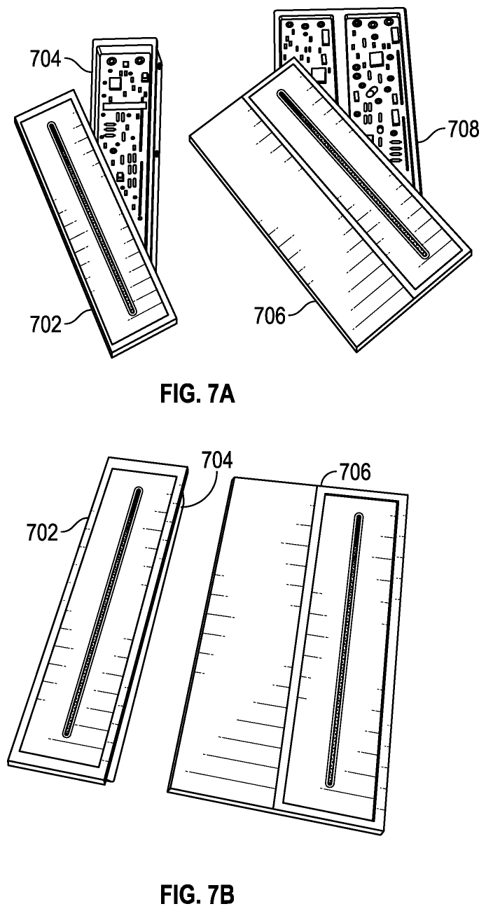

One interchangeable interface 306, on the right, has a slider as a tint selector. The slider could be implemented as a physical knob and electromechanical, optical or electronic sensing of knob and slider position, or as a touchpad for finger touching sliding action and detection, etc. Further embodiments of a tint selector are shown in FIGS. 4, 7A and 7B. Further embodiments of an interchangeable interface 306 can be input devices, output devices, I/O devices, or even a nonfunctioning dummy cover for various customizations of drivers 102, 202, 302 through attachment of an interchangeable interface 306.

In further embodiments, one, many or all of the interchangeable interfaces 306 are removable and independently operable as remote controls, for example handheld controllers. A removable interface could have a replaceable battery, or a rechargeable battery and suitable electronics for battery operation as a handheld remote control. If rechargeable, suitable electronics uses power from the power supply 310 via the driver 304 to recharge a rechargeable battery in the interchangeable interface when docked, i.e., attached to a respective driver 304. For example handheld controller remote usage, one embodiment of interchangeable interface 306 could communicate wirelessly, through radio frequency or infrared connection to a respective driver 304. A directional version could support selection of, pairing with or other driver-specific communication linkage, so that a user could pick up one of the handheld controllers and select one of the drivers 304, then optionally select one or both of the two electrochromic devices 308 to which the driver 304 is connected, and a tint selection.

FIG. 4 illustrates component physical form in embodiments of drivers 402 and interchangeable interfaces 404 of the modular smart windows system 100. In this embodiment, the L-shaped driver 402 has a back-beveled upper stem and shortened foot, with a forward-facing (relative to installation) toe that can be left unadorned or have an interchangeable interface 404 attached. At the top of the driver 402 are connectors to pigtails. A power input connector is at the bottom of the driver 402. At the bottom of the driver 402, on the face of the toe, a tint driver status LED and tint driver button may be used for testing upon installation of the driver 402. For example, after installation through an aperture 410 in a mullion (which is a vertical structure member between window panes), the user presses the tint driver button to test tinting and clearing of the window, and the tint driver status LED illuminates, blinks, counts, glows at variable level, or otherwise indicates activity of testing and operation. Alternatively, the tint driver button could activate automatic control of the smart windows, in installations where there is no interchangeable interface 404 attached to that driver 402.

The example interchangeable interface 404 in FIG. 4 has a capacitive touch slider 406, which the system uses as a tint control, so that this version is called a snap-on tint selector. By the terms snap-on and snap off, it is intended that a wide variety of attachment and detachment mechanisms could be possible in embodiments. The interchangeable interface 404 also has what is termed an “Automagic” button, which could be touch or tactile (e.g., touch-sensing or physically movable or deformable with tactile feedback to the user). This embodiment of interchangeable interface 404 also has a proximity sensor. The functioning of the proximity sensor is to detect proximity of a user, which could activate the tint driver status LED (e.g., visible through an adjacent transparent or translucent section of the interchangeable interface 404) or other indicator (e.g., integral with the interchangeable interface 404) to acknowledge proximity of the user.

FIG. 5 illustrates an embodiment of an interchangeable interface 502 as a component of the modular smart windows system 100. This embodiment shows the tint driver status LED of the tint driver glowing through a translucent or transparent section of the interchangeable interface, for example aligned with the extent of the capacitive touch slider 406. Options for various embodiments of the interchangeable interface 502 include a blank panel with matching frame, a capacitive touch tint selector interface, a light detector for occupancy detection, and air quality measurement. Air quality measurement, for example, could be performed by sensor(s) for carbon monoxide, volatile organic compounds, oxygen content, etc.

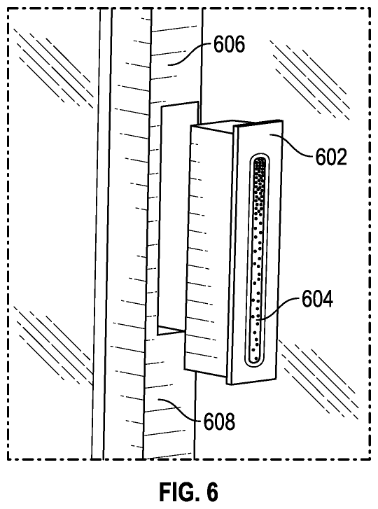

FIG. 6 illustrates a housing 602 for installation in a building interior and for receiving a driver in an embodiment of the modular smart windows system 100. For example, the housing 602 is inserted through an aperture 608 in a mullion 606, and has an aperture 604 into which the driver is inserted. The housing 602 has appropriate openings for wires.

FIG. 7A depicts disassembled physical forms of embodiments of interchangeable interfaces of the modular smart windows system 100. On the left in the drawing, a narrower embodiment of an interchangeable interface has a face panel 702 and housing 704 with electronics, together forming a capacitive touch keypad. Alternatively, this interchangeable interface has a touchpad slider. This narrower interchangeable interface is suitable for attaching to a driver that is mounted on or in a mullion, or alternatively that is mounted on or in a wall.

On the right of the drawing, a wider embodiment of an interchangeable interface has a face panel 706 and housing 708 with electronics, together forming a wall pad (or “WallPad”) point of control (POC). On the left side of the face panel 706, there are buttons and indicia for “upper row”, “lower row”, “West wall”, “North wall”, and “skylight”. On the right side of the face panel 706 there is a touchpad slider. The embodiment on the left allows for tint control of a smart window, a pair of smart windows or other designated one or set of smart windows. The embodiment on the right allows for selection of a smart window or group of smart windows, and setting of tint thereof, and may be attached (in assembled form) to a driver that is mounted on or in a wall.

FIG. 7B depicts assembled physical forms of the interchangeable interfaces of FIG. 7A. On the left of the drawing, the narrower embodiment of an interchangeable interface has the face panel 702 attached to the housing 704, enclosing the electronics. On the right of the drawing, the wider embodiment of an interchangeable interface has the face panel 706 attached to the housing 708 (not visible), enclosing the electronics.

With reference to FIGS. 1-7B, various embodiments of components in the modular smart windows system 100 have various combinations of the following features. The tint driver is designed to install next to windows. The driver fits within vertical mullions of common commercial framing systems. The driver could also be installed in-wall next to interior or even residential windows. The driver provides dual driver outputs to control two windows, e.g., the driver component includes two drivers or driver circuits. The driver communicates with a gateway via a secure wireless mesh network. Installation eliminates need for run of driver cable from each window to a central cabinet. A window pigtail connects directly to a tint driver in a vertical mullion. The tint selector keypad and other interchangeable interfaces each snap into and out of a driver. There is a simple user interface with a capacitive touch slider with an automation button. The user interface lights up when the user approaches, and sleeps when the user is away. Power and communication for the interchangeable interface is delivered through the driver, e.g., through a connector. One embodiment is projected to reduce the electronics portion of system costs by about 35% in comparison to a previous system.

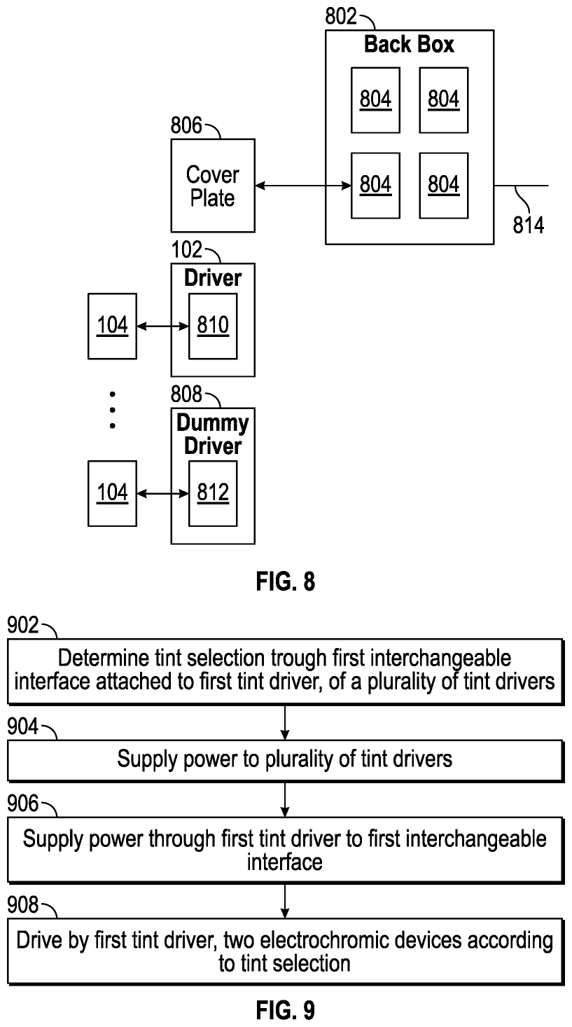

FIG. 8 illustrates a back box 802 for mounting various modular components in embodiments of the modular smart windows system. The back box 802 has multiple sockets or other mounting regions 804, in this embodiment four, that receive components. For example, a cover plate 806, a driver 102, or a dummy driver 808 can be mounted in any of the mounting regions 804. The cover plate 806 covers one or more un-used slots. The driver 102 and the dummy driver 808 can each receive an interchangeable interface 104. A wiring pigtail 814 of the back box 802 is available for connecting to wires for connection to a power supply 108 and electrochromic devices 106 (see FIG. 1). In a further embodiment, the back box 802 contains a power supply 108 and/or a gateway 110. In one embodiment, the back box 802 could be mounted to a ceiling (e.g., without tint selectors), or to a wall or in a closet, etc. With room for one to four drivers, each supporting one or two smart windows, the back box gives an in-wall capacity of one to eight smart windows and one to four tint selectors. Alternatively, multiple back-box sizes for mounting various numbers of drivers could be devised.

FIG. 9 illustrates a flow diagram of a method of operation of a modular smart windows system, which can be practiced by and with embodiments described herein and variations thereof. More specifically, the method can be practiced by a processor, which can include multiple processors and/or distributed processing through multiple modular components and/or cloud computing, in a smart windows system. Modularity of the smart windows system is expressed in embodiments with interchangeable interfaces and various components suitable for various configurations and installations of a smart windows system.

In an action 902, the system determines tint selection through a first interchangeable interface that is attached to a first tint driver. The first tint driver is one of multiple tint drivers in the system. Each tint driver can have an interchangeable interface attached, or not, in various configurations, and there are multiple types of interchangeable interfaces available. For example, interchangeable interfaces could be dimensioned and arranged to fit any or all of the tint drivers in the system, or there could be multiple sizes of interchangeable interfaces with each size fitting one size of tint driver, with multiple different sized tint drivers.

In an action 904, the system supplies power to the tint drivers. For example, a power supply is connected, through wiring, to the tint drivers. The power supply provides sufficient power for computing in the tint drivers, the user interfaces, system communication, and for the tint drivers to drive electrochromic devices.

In an action 906, the system supplies power through the first tint driver to the first interchangeable interface. Other tint drivers with attached interchangeable interfaces similarly supply power. In various embodiments, the power supply supplies power to the tint drivers, e.g., through wiring, and each interchangeable interface receives power through the respective tint driver to which the interchangeable interface is attached, e.g., through a connector.

In an action 908, two electrochromic devices are driven by the first tint driver, according to tint selection. This could include driving the two electrochromic devices to the same tint level, or selecting one electrochromic device and driving that one to the selected tint level. Other tint drivers in the system function similarly, with each tint driver having capability of driving two electrochromic devices to the same or differing tint levels according to tint selection in various embodiments. It would also be possible to mix tint drivers that can drive one, or other numbers of electrochromic devices, in modular system variations.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A modular system for smart windows, comprising:
a plurality of tint drivers each having one or more processors and electronic circuitry to drive two electrochromic devices according to a selected tint;
a plurality of interchangeable interfaces, each attachable to and removable from each of the plurality of tint drivers; and
a power supply, to supply power to the plurality of tint drivers, wherein the power supply is further to supply power via a tint driver to an interchangeable interface attached to the tint driver.

2. The system of claim 1, wherein at least one of the plurality of interchangeable interfaces operates differently than one other interchangeable interface.

3. The system of claim 1, wherein the plurality of tint drivers each are enclosed in an L-shaped housing and an interface for the housing is affixed to a surface of the housing.

4. The system of claim 3, wherein the L-shaped housing is tapered at one end.

5. The system of claim 4, wherein the L-shaped housing is inserted in a mullion between two electrochromic devices.

6. The system of claim 1, wherein the interchangeable interfaces comprises a faceplate having a slider touchpad configured to change a tint level of an electrochromic device.

7. The system of claim 6, wherein the faceplate operates through a capacitive interface.

8. The system of claim 1, wherein the power supply is coupled through pigtail cabling.

9. The system of claim 1, further comprising a gateway communicating with each of the tint drivers through a wireless connection.

10. A method of operating electrochromic devices, comprising:
providing a plurality of tint drivers each having one or more processors and electronic circuitry to drive two electrochromic devices according to a selected tint;
providing a plurality of interchangeable interfaces, each attachable to and removable from each of the plurality of tint drivers, wherein the processors and electronic circuitry are configured to;
determine a tint level through one of the plurality of interchangeable interfaces; and
drive two electrochromic devices according to the tint level.

11. The method of claim 10, wherein the plurality of interchangeable interfaces are capacitively operated.

12. The method of claim 10, further comprising:
providing power to the plurality of interchangeable interfaces through a corresponding tint driver.

13. The method of claim 10, wherein the two electrochromic devices are driven to a same tint level.

14. The method of claim 10, wherein the two electrochromic devices are driven to a differing tint level.

15. The method of claim 10, wherein the plurality of interchangeable interfaces operate through a capacitive interface.

16. The method of claim 10, wherein one of the plurality of interfaces operates through a differing mechanism than another one of the plurality of interfaces.

17. The method of claim 17, wherein one mechanism includes a capacitive mechanism.

18. The method of claim 17, wherein one mechanism includes a light detection mechanism.
